(19) United States
(12) Patent Application Publication
(10) Pub. No.: US 2006/0022897 A1
(43) Pub. Date: Feb. 2, 2006

(54) Method and system for transforming a display into a mirror

(76) Inventors: Lisa A. Windover, San Francisco, CA (US); Jonathan N. Simon, Castro Valley, CA (US); Steven A. Rosenau, Mountain View, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/900,681

(22) Filed: Jul. 27, 2004

(51) Int. Cl. G09G 3/00

(52) U.S. Cl. 345/32

(57) ABSTRACT

A display includes a convertible mirror layer overlying at least a portion of a display screen. The convertible mirror layer converts between a transparent state and a reflective state.

### BACKGROUND

Numerous consumer products display images or information to a user. Examples of such products include cellular telephones and computer screens. Manufacturers and designers of consumer products are constantly working on improvements to their products in order to stay ahead of their competition.

One way a manufacturer or product designer improves a product is to offer new or additional functions in their product. This allows a user to experience the improved product in a new way. Additionally, the improved product can replace multiple devices, since the improved product performs all of the functions of the multiple devices. For example, a cellular telephone can be used as a telephone, a camera, and an Internet device.

### SUMMARY

In accordance with the invention, a method and system for transforming a display into a mirror are provided. A display includes a convertible mirror layer overlying at least a portion of a display screen. The convertible mirror layer converts between a transparent state and a reflective state. The transparent state allows a user to view one or more images displayed on the display screen. The convertible mirror layer may be in a transmissive state until a user selects a mirror function associated with the display. Selection of the mirror function causes the convertible mirror layer to convert to a reflective state. Alternatively, the convertible mirror layer may be in a reflective state until a user selects a display function associated with the display. Selection of the display function causes the convertible mirror layer to convert to a transmissive state. The user may also select the amount of reflectivity for the convertible mirror layer.

### BRIEF DESCRIPTION OF THE DRAWINGS

The invention will best be understood by reference to the following detailed description of embodiments in accordance with the invention when read in conjunction with the accompanying drawings, wherein:

FIG. 1 is a block diagram of a display device in an embodiment in accordance with the invention;

FIG. 2 is a cross-sectional view of a display in an embodiment in accordance with the invention;

FIG. 3 is a diagrammatic view of a convertible mirror in accordance with the embodiment of FIG. 2;

FIG. 4 is a flowchart of a method for transforming a display into a mirror in an embodiment in accordance with the invention;

FIG. 5A is a perspective view of a first cellular telephone in an embodiment in accordance with the invention;

FIG. 5B is a perspective view of a second cellular telephone in an embodiment in accordance with the invention;

FIG. 5C is a perspective view of the cellular telephone of FIG. 5A and FIG. 5B with a display converted to a mirror;

FIGS. 6A-6B are perspective views of an informational device in an embodiment in accordance with the invention;

FIG. 7 is a perspective view of a television and remote in an embodiment in accordance with the invention; and

FIG. 8 is a graph of reflectivity versus wavelength in an embodiment in accordance with the invention.

### DETAILED DESCRIPTION

Embodiments in accordance with the invention relate to a method and system for transforming a display into a mirror. The following description is presented to enable one skilled in the art to make and use embodiments in accordance with the invention, and is provided in the context of a patent application and its requirements. Various modifications to the disclosed embodiments will be readily apparent to those skilled in the art, and the generic principles herein may be applied to other embodiments. Thus, the invention is not intended to be limited to the embodiments shown, but is to be accorded the widest scope consistent with the appended claims and with the principles and features described herein.

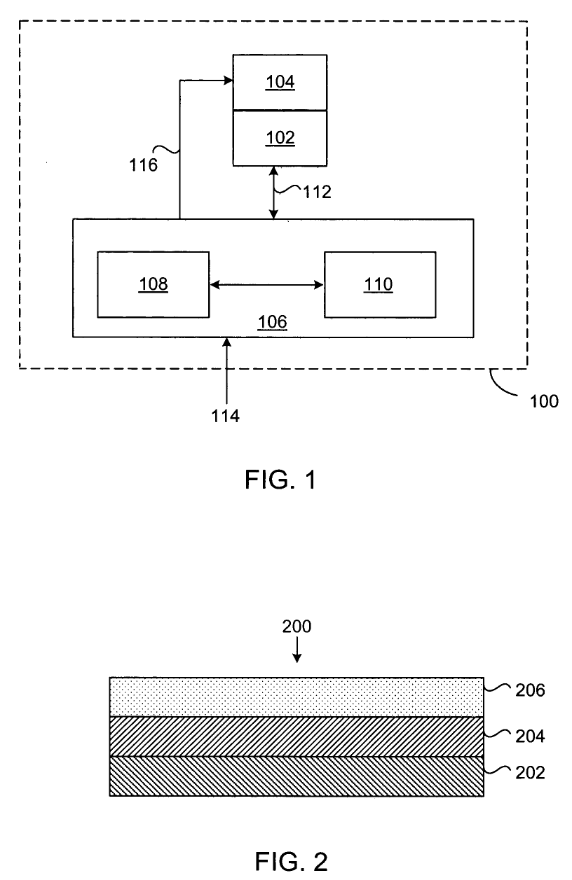

With reference to the figures and in particular with reference to FIG. 1, there is shown a block diagram of a display device in an embodiment in accordance with the invention. Display device 100 includes display 102, convertible mirror 104, and controller 106. Display 102 is implemented as a flat screen display, such as a liquid crystal display (LCD) or a plasma display in an embodiment in accordance with the invention. In other embodiments in accordance with the invention, display 102 may be implemented with other types of displays, including, but not limited to, a light-emitting diode (LED) display, an organic-LED display (OLED), an electro-wetting display, and a porous silicon display.

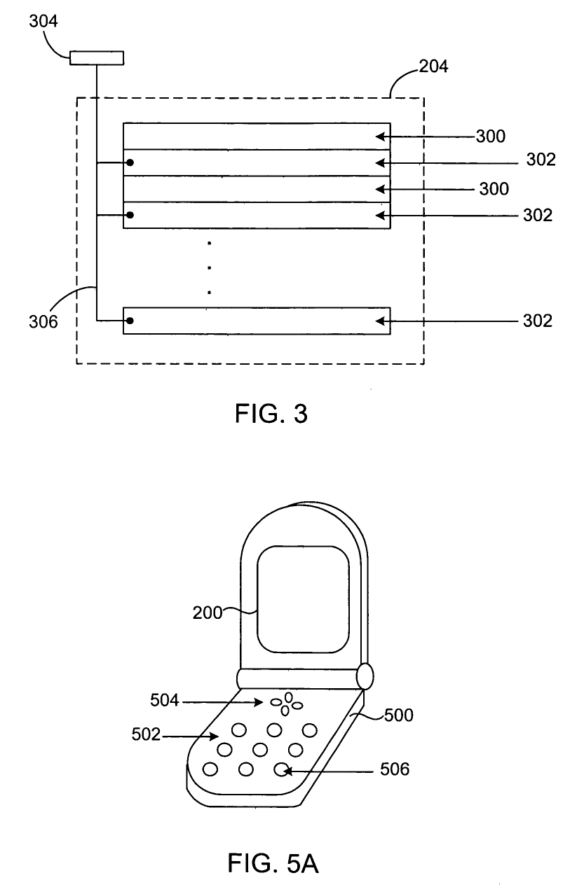

Controller 106 includes both hardware 108 and software 110 for generating and processing images displayed on display 102. Data relating to the images displayed on display 102 are transmitted to and from display 102 via signal line 112. In an embodiment in accordance with the invention, convertible mirror 104 is in a transparent state until a mirror function associated with display 102 is selected. A user can view one or more images on display 102 while the convertible mirror layer is in the transparent state. When a user selects the mirror function selection signal 114 is transmitted to controller 106. A control signal is then transmitted to convertible mirror 104 via signal line 116, which causes convertible mirror 104 to convert to a reflective state. The mirror function is discussed in more detail in conjunction with FIG. 3 and FIGS. 5-7.

In another embodiment in accordance with the invention, convertible mirror 104 is in a reflective state until a display function associated with display device 100 is selected. Selection signal 114 is transmitted to controller 106 in response to the user selecting the display function. A control signal is then transmitted to convertible mirror 104 via signal line 116, which causes convertible mirror 104 to convert to a transmissive state.

FIG. 2 is a cross-sectional view of a display in an embodiment in accordance with the invention. Display 200 includes display screen 202, convertible mirror layer 204, and cover 206. Convertible mirror layer 204 is formed on top of display screen 202. One example of convertible mirror layer 204 is a distributed Bragg reflector, which is described in conjunction with FIG. 3.

Convertible mirror layer 204 covers all of display screen 202 in the FIG. 2 embodiment. Convertible mirror layer 204 may cover only portions of display screen 202 in other embodiments in accordance with the invention. For example, only the bottom half or the lower right-hand corner of display screen 202 may be covered by convertible mirror layer 204.

In an embodiment in accordance with the invention, convertible mirror layer 204 switches from a transparent state to a reflective state when a mirror function associated with display 200 is selected. Convertible mirror layer 204 returns to a transparent state when the mirror function is de-selected. In another embodiment in accordance with the invention, convertible mirror layer 204 switches from a reflective state to a transmissive state when a display function is selected. Convertible mirror layer 204 returns to the reflective state when the display function is de-selected.

Cover 206 protects convertible mirror layer 204 from damage and contamination. Cover 206 is typically implemented as a glass cover in an embodiment in accordance with the invention. In other embodiments in accordance with the invention, cover 206 may be implemented as other types of covers, such as, for example, a plastic cover. Additionally, cover 206 is typically optional, and in other embodiments in accordance with the invention, cover 206 is not included in display 200.

Referring now to FIG. 3, there is shown a diagrammatic view of a convertible mirror in accordance with the embodiment of FIG. 2. Convertible mirror 204 is implemented as a distributed Bragg reflector in the FIG. 3 embodiment. The materials that form convertible mirror 204 include alternating layers 300, 302 of quarter-wavelength (λ/4n₁), (λ/4 n₂) thick index material, respectively. The variables n₁ and n₂ are the index of refraction of the alternating layers 300, 302, respectively. Thus, the index of refraction of layers 300 differs from the index of refraction of layers 302.

The material in one of the layers, such as in layers 302, is composed of an electro-optical material. The index of refraction for an electro-optical material changes when an electric field (i.e., using a voltage or current) is applied to the material. In the FIG. 3 embodiment, layers 300 have an index of refraction of n₁ and layers 302 of n₁ when convertible mirror 204 is in a transparent state. When a voltage or current is applied to input 304 and transmitted to layers 302 via signal line 306, the index of refraction for layers 302 changes from n₁ to n₂. This change controls convertible mirror 204 and causes layers 300, 302 to transform into a reflective state in an embodiment in accordance with the invention. Convertible mirror 204 remains in a reflective state until the voltage or current is no longer applied to input 304. Layers 300, 302 return to a transparent state when the voltage or current is no longer applied to input 304.

In another embodiment in accordance with the invention, convertible mirror 204 converts to a transparent state when a voltage or current is applied to input 304 and returns to a reflective state when the voltage or current is no longer applied to input 304. Layers 300 have an index of refraction of n₁ and layers 302 of n₂ when convertible mirror 204 is in a reflective state. When a voltage or current is applied to input 304 and transmitted to layers 302 via signal line 306, the index of refraction for layers 302 changes from n₂ to n₁. This change controls convertible mirror 204 and causes layers 300, 302 to transform into a transmissive state in an embodiment in accordance with the invention.

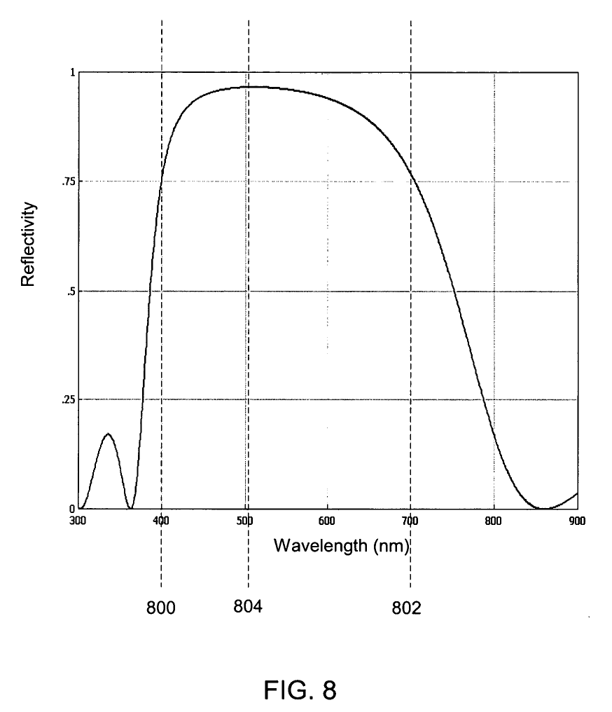

The number of layers 300, 302 used to construct convertible mirror 204 is determined by the index of refraction of each layer, the amount of achievable change in the index of refraction in one or more layers, and the desired reflectivity. In an embodiment in accordance with the invention, mirror 204 is reflective over a broad range of wavelengths. The reflectivity range is discussed in more detail in conjunction with FIG. 8. Other embodiments in accordance with the invention are not limited to reflectivity over a broad range of wavelengths. Convertible mirror 204 may be designed to be reflective at any desired wavelength or over any desired wavelength range. For example, the amount of reflectivity at a desired peak wavelength and the reflectivity value across a range of wavelengths can be changed by adjusting the number of layers, the index of refraction of each layer, or the thickness of each layer in the convertible mirror.

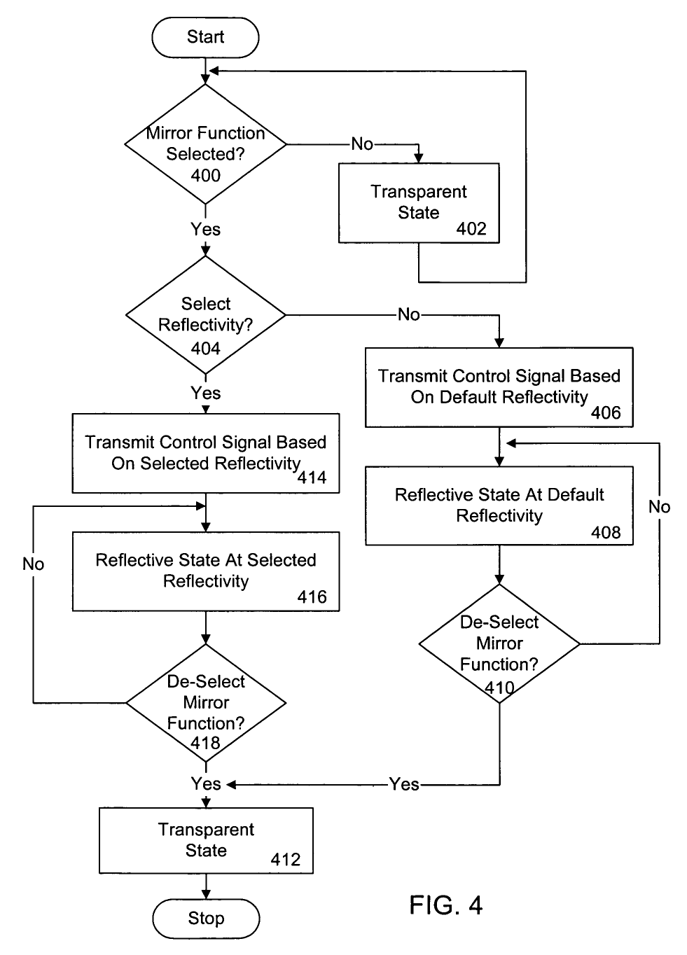

FIG. 4 is a flowchart of a method for transforming a display into a mirror in an embodiment in accordance with the invention. Initially a determination is made at block 400 as to whether a user has selected a mirror function. If not, the process continues at block 402 where convertible mirror layer is in a transparent state. The method then returns to block 400.

When a user has selected the mirror function, the method passes to block 404 where a determination is made as to whether a user has selected a reflectivity level. In an embodiment in accordance with the invention, a user can select a desired amount of reflectivity of the convertible mirror layer. For example, a user may want the mirror to have a seventy-five percent reflectivity or a ninety percent reflectivity.

If the user has not selected a reflectivity level, a control signal is transmitted to the convertible mirror layer that causes the layer to convert to a mirror at a default reflectivity. These steps are shown in blocks 406 and 408, respectively. In an embodiment in accordance with the invention, the control signal causes an electric field to be applied to input 304 (see FIG. 3). The electric field is generated at a level that causes the convertible mirror layer to convert to a reflective state at the default level of reflectivity. A display or device manufacturer or a user may set the default level of reflectivity in an embodiment in accordance with the invention.

A determination is then made at block 410 as to whether the user has de-selected the mirror function. If not, the method returns to block 408, where the convertible mirror layer remains in the reflective state until the user de-selects the mirror function. When the user de-selects the mirror function, the process passes to block 412 where the convertible mirror layer converts to a transparent state, and the process ends.

Referring again to block 404, when a user selects a reflectivity level, a control signal is transmitted to the convertible mirror layer that causes the layer to convert to a mirror at the selected level of reflectivity. These steps are shown in blocks 414 and 416, respectively. In an embodiment in accordance with the invention, the control signal causes an electric field to be applied to input 304 (see FIG. 3). The electric field is generated at a level that causes the convertible mirror layer to convert to a reflective state at the desired level of reflectivity. A user may select the level of reflectivity, for example, through an options setting in the device or through a dialog or pull-down menu in a user interface associated with the device.

A determination is then made at block 418 as to whether the user has de-selected the mirror function. If not, the method returns to block 416, where the convertible mirror layer remains in the reflective state until the user de-selects the mirror function. When the user de-selects the mirror function, the process passes to block 412 where the convertible mirror layer converts to a transparent state, and the process ends.

In an embodiment in accordance with the invention, convertible mirror layer 204 switches from a reflective state to a transmissive state when a display function is selected. Convertible mirror layer 204 returns to the reflective state when the display function is de-selected.

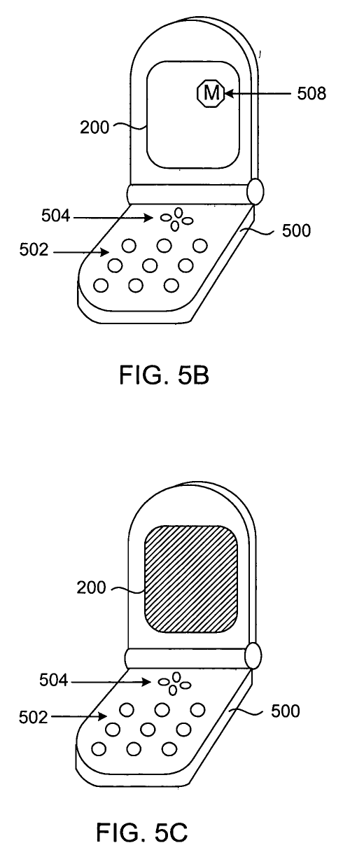

Referring now to FIG. 5A, there is shown a perspective view of a first cellular telephone in an embodiment in accordance with the invention. Cellular telephone 500 includes display 200, keypad 502 (buttons 0-9, # and *) and directional button or buttons 504. Display 200 displays information to a user, including one or more user interfaces for telephone 500. Display 200 also displays the various features associated with telephone 500. These features may include sending and receiving electronic mail and text messages, downloading and playing games, music, and pictures, and setting the functions of telephone 500. Keypad 504 and directional buttons 506 may be use to access and/or select the various features and functions of telephone 500. In other embodiments in accordance with the invention, cellular telephone 500 may be implemented with components in addition to, or in place of, the components shown in FIG. 5A. For example, cellular telephone 500 may also include a camera lens and camera function.

One of the features in cellular telephone 500 is a mirror function. When a user presses button 506, for example, display 200 transforms into a mirror. FIG. 5C is a perspective view of the cellular telephone of FIG. 5A with a display converted to a mirror. The mirror function is de-selected when the user presses button 506 a second time. In an embodiment in accordance with the invention, pressing button 506 to select the mirror function causes a voltage or current to be applied to input 304 in FIG. 3. And pressing button 506 a second time de-selects the mirror function and results in the removal of the voltage or current from input 304.

FIG. 5B is a perspective view of a second cellular telephone in an embodiment in accordance with the invention. Using one or more directional buttons 504, a user selects icon 508 to convert display 200 into a mirror. FIG. 5C is a perspective view of the cellular telephone of FIG. 5B with a display converted to a mirror. The mirror function is de-selected, for example, when the user presses a button in the keypad 502 or in the directional buttons 504. In an embodiment in accordance with the invention, selecting icon 508 causes a voltage or current to be applied to input 304 in FIG. 3. And pressing a button to de-select the mirror function causes the removal of the voltage or current from input 304.

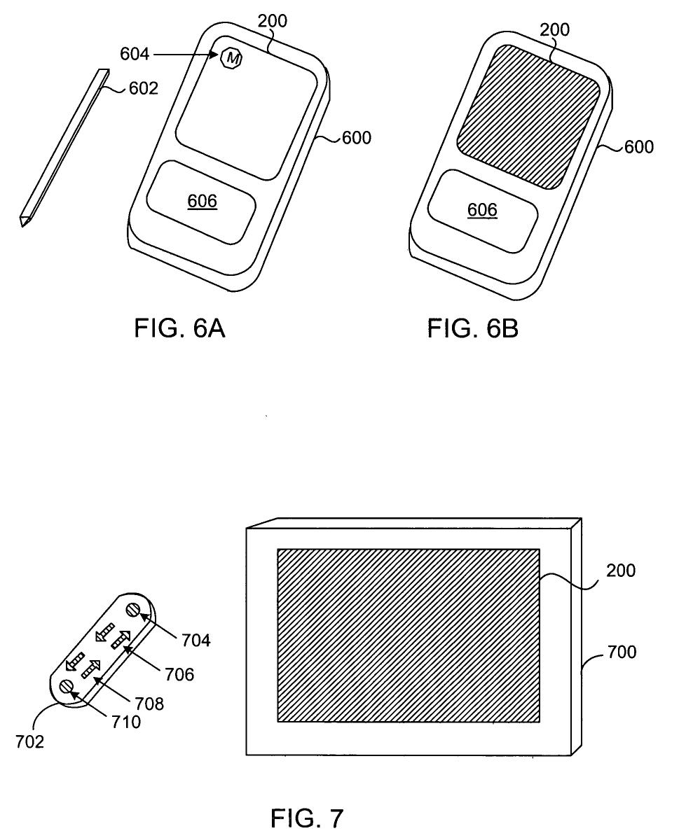

Referring now to FIGS. 6A-6B, there are shown perspective views of an informational device in an embodiment in accordance with the invention. Informational device 600 includes any device that displays images or data to a user. Examples of such devices include, but are not limited to, personal digital assistants (PDA), computer monitors, and “picture” displays that are mounted on a wall and set to display one or more particular images, such as, for example, digital art or pictures. In other embodiments in accordance with the invention, informational device 600 may be implemented with components in addition to, or in place of, the components shown in FIG. 6A. For example, informational device 600 may also include a camera lens and camera function.

A user may select a mirror function in informational device 600 by placing the tip of stylus 602 on the area of display 200 displaying icon 604. Selection of the mirror function causes display 200 to convert to a mirror in an embodiment (see FIG. 6B). To deselect the mirror function, the user may, for example, touch display 200 with stylus 502 a second time.

In another embodiment in accordance with the invention, information device 600 includes touchpad 606. A user may select the mirror function by moving his or her finger over touchpad 606 to move a cursor (not shown). When the cursor is pointing to icon 604, the user selects the mirror function by touching touchpad 606 a second time. The user may then de-select the mirror function, for example, by touching touchpad 606 again.

FIG. 7 is a perspective view of a television and a remote in an embodiment in accordance with the invention. Television 700 includes a display 200 and remote 702. Remote 702 includes power button 704, channel selection buttons 706, volume selection buttons 708, and mirror function button 710 in an embodiment in accordance with the invention. Remote 702 controls television 700 through these various buttons. In other embodiments in accordance with the invention, television 700 and remote 702 may be implemented with components in addition to, or in place of, the components shown in FIG. 7.

When a user presses mirror function button 710, display 200 converts to a mirror in an embodiment in accordance with the invention. When the user presses mirror function button 710 a second time, display 200 coverts to a transparent state, thereby allowing the user to view images displayed on television 700. In other embodiments in accordance with the invention, pressing mirror function button 710 a first time causes display 200 to convert to a transparent state and pressing the button 710 a second time causes display 200 to convert to a reflective state.

In other embodiments in accordance with the invention, a mirror function associated with display 200 may be selected through techniques other than button 710. For example, the mirror function may be selected through a menu displayed on display 200 or by the user touching a portion of display 200.

Although embodiments have been described with reference to the selection of a mirror function, other embodiments in accordance with the invention are not limited to this implementation. Embodiments in accordance with the invention may convert a display from a reflective state to a transmissive state when a user selects a display function associated with the display. The display returns to the reflective state when the user de-selects the display function.

Referring now to FIG. 8, there is shown a graph of reflectivity versus wavelength in an embodiment in accordance with the invention. A convertible mirror associated with this graph is reflective over a broad range of wavelengths. The amount of reflectivity varies between minimum wavelength 800 and maximum wavelength 802 in an embodiment in accordance with the invention. At the minimum wavelength of 400 nanometers, the reflectivity of the mirror is approximately seventy-five percent. At the maximum wavelength of 700 nanometers, the reflectivity is approximately seventy-five percent. A maximum reflectivity of approximately ninety-five percent occurs at a peak wavelength 804, which in an embodiment is approximately 500 nanometers.

The relationship between wavelength and reflectivity can differ from that shown in FIG. 8 in other embodiments in accordance with the invention. A convertible mirror may operate, for example, over any wavelength range and may be constructed with any desired level of reflectivity. The type and properties of the materials used to construct a convertible mirror will determine the wavelength range and amount of reflectivity. For example, the range and amount of reflectivity are determined by the number of layers 300, 302 that form convertible mirror 204, the indexes of refraction of layers 300, 302, and the electro-optical effect associated with layer 302. In other embodiments in accordance with the invention, the amount of reflectivity at a desired peak wavelength and the reflectivity value across a range of wavelengths can be changed, for example, by adjusting the number of layers, the index of refraction of each layer, or the thickness of each layer in the convertible mirror.

1. A device, comprising:
a display screen for displaying one or more images; and
a convertible mirror layer overlying at least a portion of the display screen.

2. The device of claim 1, further comprising a cover layer.

3. The device of claim 1, wherein the convertible mirror layer is in a transparent state when a user views an image on the display screen.

4. The device of claim 1, wherein the convertible mirror layer is in a reflective state until a user converts the convertible mirror layer to a transparent state to view an image on the display screen.

5. The device of claim 1, wherein the convertible mirror layer is comprised of an electro-optical material.

6. The device of claim 5, wherein the convertible mirror layer comprises a distributed Bragg reflector.

7. A display device, comprising:
a display screen for displaying one or more images;
a convertible mirror layer; and
a controller for transmitting a first control signal and a second control signal to the convertible mirror layer.

8. The display device of claim 7, wherein the controller transmits the first control signal in response to a user selecting a mirror function associated with the display device and transmits the second control signal in response to a user de-selecting the mirror function.

9. The display device of claim 8, wherein a reflectivity level for the convertible mirror layer is based on the first control signal.

10. The display device of claim 7, wherein the controller transmits the first control signal in response to a user selecting a display function associated with the display device and transmits the second control signal in response to a user de-selecting the display function.

11. The display device of claim 10, wherein a reflectivity level for the convertible mirror layer is based on the first control signal.

12. The display device of claim 7, wherein the convertible mirror layer is comprised of an electro-optical material.

13. The display screen of claim 12, wherein the convertible mirror lyaer comprises a distributed Bragg reflector.

14. A method for transforming a display into a mirror, wherein the display comprises a convertible mirror and a display screen, the method comprising:
transmitting a first control signal to the convertible mirror; and
converting the convertible mirror to a reflective state in response to the first control signal.

15. The method of claim 14, wherein transmitting a first control signal to the convertible mirror comprises transmitting a first control signal to the convertible mirror in response to a user selecting a mirror function associated with the display.

16. The method of claim 14, wherein transmitting a first control signal to the display comprises transmitting a first control signal to the convertible mirror in response to a user de-selecting a display function associated with the display.

17. The method of claim 14, further comprising:
transmitting a second control signal to the convertible mirror; and
converting the convertible mirror to a transmissive state in response to the second control signal.

18. The method of claim 17, wherein transmitting a second control signal to the convertible mirror comprises transmitting a second control signal to the convertible mirror in response to a user de-selecting a mirror function associated with the display.

19. The method of claim 17, wherein transmitting a second control signal to the convertible mirror comprises transmitting a second control signal to the convertible mirror in response to a user selecting a display function associated with the display.

20. The method of claim 14, further comprising:
selecting a level of reflectivity; and
converting the convertible mirror to the reflective state at the selected level of reflectivity in response to the first control signal.
